(19) United States
(12) Patent Application Publication
(10) Pub. No.: US 2008/0177808 A1
(43) Pub. Date: Jul. 24, 2008

(54) METHOD AND SYSTEM FOR ENHANCED IMAGING WORKFLOW

(75) Inventor: Indira Srinivasa Raghavan, Bangalore (IN)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/626,415

(22) Filed: Jan. 24, 2007

(51) Int. Cl. G06F 17/00

(52) U.S. Cl. 707/204

(57) ABSTRACT

A method of image management is presented. The method includes selecting one or more objects from an object listing for deletion, where the one or more objects comprise an archived object, an unarchived object, or both. Further, the method includes determining archival status of the one or more selected objects, where the archival status comprises one of an archived state or an unarchived state. Also, the method includes moving the unarchived objects to a first storage, where the first storage is configured to facilitate restoration of the unarchived objects. Systems and computer-readable medium that afford functionality of the type defined by this method are also contemplated in conjunction with the present technique.

### BACKGROUND

The invention relates generally to an image management system, and more particularly to methods and systems for management of acquired image data.

Diagnostic imaging has emerged into an essential aspect of patient care. Medical images that are obtained during a diagnostic imaging session have evolved as tools that allow a clinician non-invasive means to view anatomical cross-sections of internal organs, tissues, bones and other anatomical regions of a patient. More particularly, the medical images serve the clinician in diagnosis of disease states, determination of suitable treatment options and/or monitoring the effects of treatment, to name a few. As will be appreciated, medical images may be obtained from a broad spectrum of imaging modalities, such as, but not limited to computed tomography (CT) imaging, ultrasound imaging, magnetic resonance (MR) imaging, digital mammography, X-ray imaging, nuclear medicine imaging, or positron emission tomography (PET) imaging.

Medical data management systems have been employed to facilitate organization and management of a variety of data, including patient data, information on procedures and studies that have been scheduled for patients, reports and notes from doctors and technologists relating to procedures and studies, medical images, lab results, billing and insurance information, and many other types of information relevant to medical professionals and management of medical facilities. Different types of medical information may be organized into a workflow, in which the necessary data is passed from one staff member, doctor, group, or department to the next, to assist in providing each staff member with relevant information. Consequently, a considerable amount of examination data is generated that in turn needs to be stored. Unfortunately, this large amount of data that must be stored may overwhelm the limited storage space available locally on the medical imaging system. This may be especially problematic in systems that handle high volumes of medical images that place high demands on storage systems, such as databases and other long-term storage devices.

As will be appreciated, various techniques have been proposed to effectively manage the capacity of a storage device. By way of example, some currently available techniques utilize a data replacement technique where the least recently used data is deleted from a temporary storage device to be replaced by the most recently acquired data. Such techniques are not entirely satisfactory in maintaining working storage in medical imaging applications as use of this method may result in accidental loss of desired information. For example, if the medical imaging system receives additional image files after the storage capacity is exceeded, a storage area for new files is generally obtained by deleting old files. This process of deleting old image files may disadvantageously lead to accidental deletion of desired image files.

Additionally, presently available techniques entail moving the image files temporarily stored on the hard disk drive of the imaging system to external storage media, such as, but not limited to, a database, an archival site and/or removable media such as a digital versatile disc (DVD) or a magnetic-optical (MO) disc, in order to permanently retain the medical records. These stored images may then be retrieved from the storage media for further analysis. However, conventionally, moving medical records to the removable media is performed manually, thereby resulting in a tedious and expensive process. In addition, as manual operations of image storage tend to get complex or multiple people handle the manual deletion of image files, important image data may inadvertently be lost, while unimportant image data may be retained permanently, thereby leading to needless wastage of precious storage space.

Hence, deletion of exams in the imaging system is vital to the management of limited storage space available on the local system as the local disk is typically employed for temporary storage of exams while long-term archival is possible on systems such as picture archiving and communications systems (PACS). Furthermore, deletion of exams without being archived to discard defective exams is also a critical need. Consequently, restoration of deleted exams to the local database is crucial to prevent data loss due to an accidental delete. Nevertheless, storing archived exams in Recycle Bin leads to wasteful usage of Recycle Bin space.

It may therefore be desirable to develop a robust technique and system for deleting image data that advantageously facilitates substantially superior management of storage space available on the medical imaging system. In particular, there is a need for a system that may be configured to aid in enhancing ease of managing image data, thereby simplifying the image data management workflow and improving the possibilities of averting accidental deletion of relevant exam data.

### BRIEF DESCRIPTION

In accordance with aspects of the present technique, a method for image management is presented. The method includes selecting one or more objects from an object listing for deletion, where the one or more objects comprise an archived object, an unarchived object, or both. Further, the method includes determining archival status of the one or more selected objects, where the archival status comprises one of an archived state or an unarchived state. Also, the method includes moving the unarchived objects to a first storage, where the first storage is configured to facilitate restoration of the unarchived objects. Computer-readable medium that afford functionality of the type defined by this method is also contemplated in conjunction with the present technique.

In accordance with further aspects of the present technique a system for image management is presented. The system includes an acquisition subsystem configured to acquire one or more objects representative of one or more patients. Additionally, the system includes a processing subsystem in operative association with the acquisition subsystem and including an image management platform configured to select one or more objects from an object listing for deletion, where the one or more objects comprise an archived object, an unarchived object, or both, determine archival status of the one or more objects, where the archival status comprises one of an archived state or an unarchived state, and move the unarchived objects to a first storage, where the first storage is configured to facilitate restoration of the unarchived objects.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary diagnostic system, in accordance with aspects of the present technique;

FIG. 2 is a block diagram illustrating an embodiment of the diagnostic system of FIG. 1, in accordance with aspects of the present technique;

FIG. 3 is a flow chart illustrating an exemplary process of image management, in accordance with aspects of the present technique;

FIGS. 4-5 are diagrammatic illustrations of the exemplary process of image management depicted in FIG. 3, in accordance with aspects of the present technique;

FIG. 6 is a flow chart illustrating another exemplary process of image management, in accordance with aspects of the present technique;

FIG. 7 is a diagrammatic illustration of the exemplary process of image management depicted in FIG. 6, in accordance with aspects of the present technique;

FIG. 8 is a flow chart illustrating yet another exemplary process of image management, in accordance with aspects of the present technique; and

FIG. 9 is a diagrammatic illustration of the exemplary process of image management depicted in FIG. 8, in accordance with aspects of the present technique.

### DETAILED DESCRIPTION

As will be described in detail hereinafter, a method for image management and a system for image management configured to optimize and simplify image management workflow, are presented. Employing the method and system described hereinafter, the system for image management may be configured to move deleted image objects to a temporary storage, thereby aiding a clinician in retrieving image objects that have been deleted accidentally. Also, usage of limited temporary storage resources may be optimized by employing the method and system of image management.

Although, the exemplary embodiments illustrated hereinafter are described in the context of a medical imaging system, it will be appreciated that use of the diagnostic system in industrial applications are also contemplated in conjunction with the present technique.

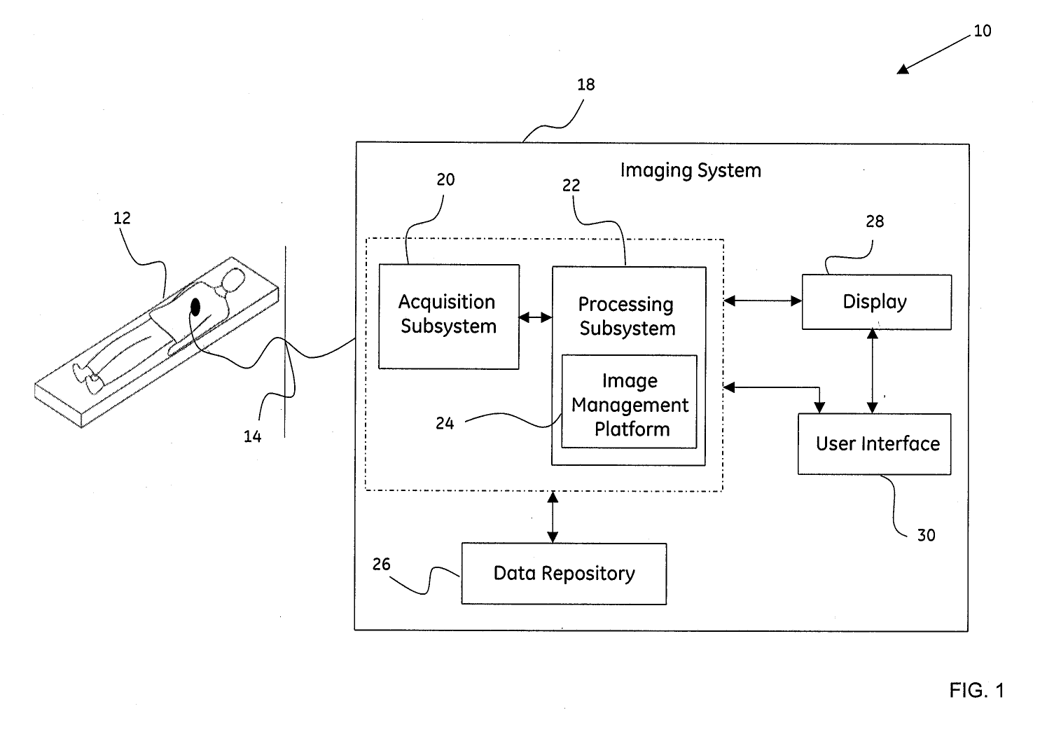

FIG. 1 is a block diagram of an exemplary system 10 for use in diagnostic imaging in accordance with aspects of the present technique. The system 10 may be configured to acquire image data from a patient 12 via an image acquisition device 14. In one embodiment, the image acquisition device 14 may include a probe, where the probe may include an invasive probe, or a non-invasive or external probe, such as an external ultrasound probe, that is configured to aid in the acquisition of image data. Also, in certain other embodiments, image data may be acquired via one or more sensors (not shown) that may be disposed on the patient 12. By way of example, the sensors may include physiological sensors (not shown) such as electrocardiogram (ECG) sensors and/or positional sensors such as electromagnetic field sensors or inertial sensors. These sensors may be operationally coupled to a data acquisition device, such as an imaging system, via leads (not shown), for example.

The system 10 may also include a medical imaging system 18 that is in operative association with the image acquisition device 14. It should be noted that although the exemplary embodiments illustrated hereinafter are described in the context of a medical imaging system, other imaging systems and applications such as industrial imaging systems and non-destructive evaluation and inspection systems, such as pipeline inspection systems, liquid reactor inspection systems, are also contemplated. Additionally, the exemplary embodiments illustrated and described hereinafter may find application in multi-modality imaging systems that employ ultrasound imaging in conjunction with other imaging modalities, position-tracking systems or other sensor systems. Furthermore, it should be noted that although the exemplary embodiments illustrated hereinafter are described in the context of a medical imaging system, such as, but not limited to, an ultrasound imaging system, an optical imaging system, a computed tomography (CT) imaging system, a magnetic resonance (MR) imaging system, an X-ray imaging system, or a positron emission tomography (PET) imaging system, other imaging systems, such as, but not limited to, a pipeline inspection system, a liquid reactor inspection system, or other imaging systems are also contemplated in accordance with aspects of the present technique.

In a presently contemplated configuration, the medical imaging system 18 may include an acquisition subsystem 20 and a processing subsystem 22. Further, the acquisition subsystem 20 of the medical imaging system 18 may be configured to acquire image data representative of one or more anatomical regions of interest in the patient 12 via the image acquisition device 14. The image data acquired from the patient 12 may then be processed by the processing subsystem 22.

Additionally, the image data acquired and/or processed by the medical imaging system 18 may be employed to aid the clinician in identifying disease states, assessing need for treatment, determining suitable treatment options, and/or monitoring the effect of treatment on the disease states. It may be noted that the terms treatment and therapy may be used interchangeably. In certain embodiments, the processing subsystem 22 may be further coupled to a storage system, such as a data repository 26, where the data repository is configured to receive image data.

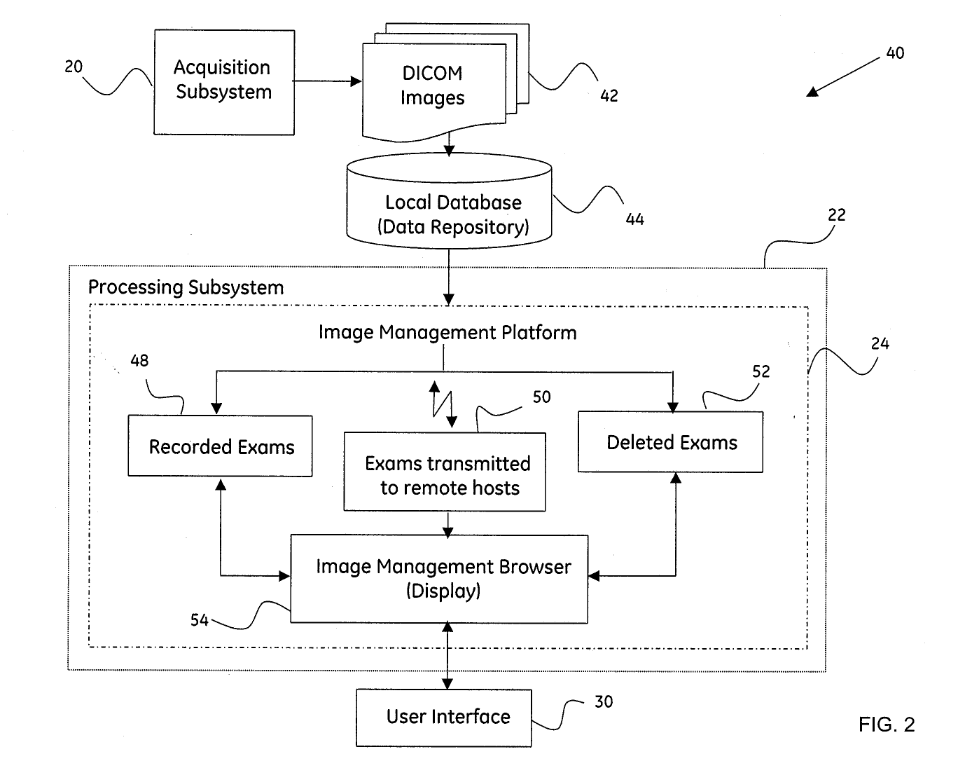

In accordance with exemplary aspects of the present technique, the processing subsystem 22 may include an image management platform 24 that is configured to aid in the management of images acquired via the medical imaging system 18 and will be described in greater detail with reference to FIGS. 2-9. In one embodiment, the image management platform 24 may include an image management browser (not shown) that may be configured to allow the clinician to manage and/or organize the images acquired by the medical imaging system 18.

As illustrated in FIG. 1, the medical imaging system 18 may include a display 28 and a user interface 30. However, in certain embodiments, such as in a touch screen, the display 28 and the user interface 30 may overlap. Also, in some embodiments, the display 28 and the user interface 30 may include a common area. In accordance with aspects of the present technique, the display 28 of the medical imaging system 18 may be configured to display an image generated by the medical imaging system 18 based on the image data acquired via the image acquisition device 14. Additionally, in accordance with further aspects of the present technique, the image management browser may be visualized on the display 28, and will be described in greater detail with reference to FIGS. 2-9.

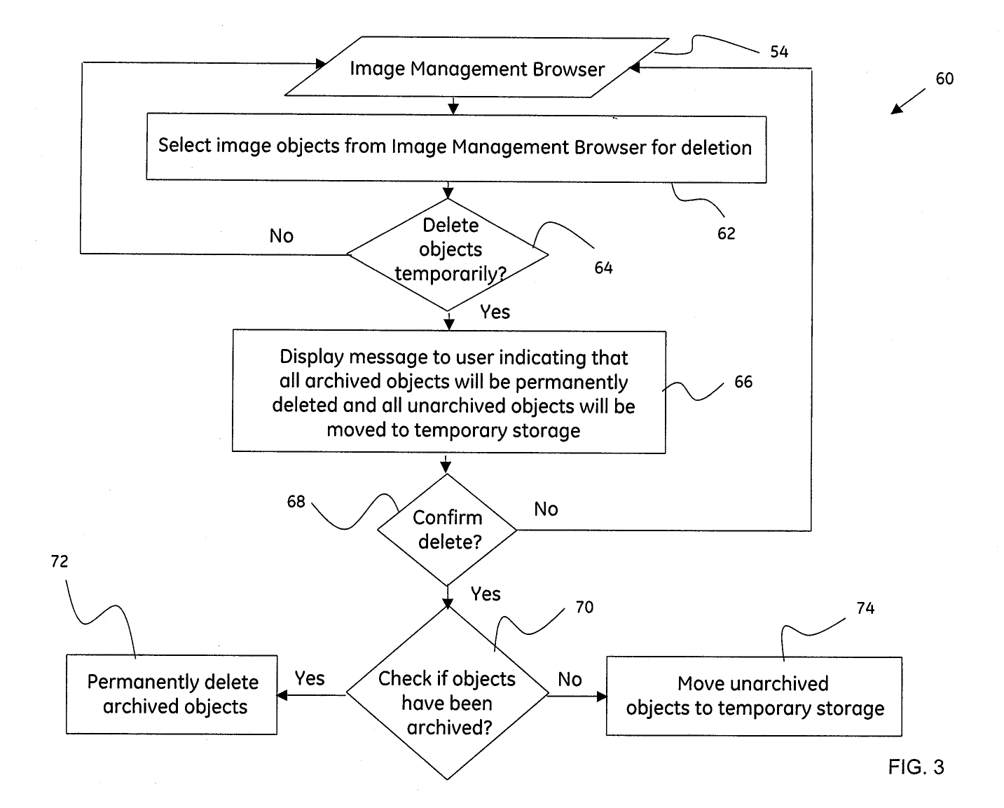

Further, the user interface 30 of the medical imaging system 18 may include a human interface device (not shown) configured to facilitate the clinician in organizing and/or managing image data displayed on the display 28. The human interface device may include a mouse-type device, a trackball, a joystick, a stylus, or a touch screen configured to facilitate the user to identify the one or more regions of interest requiring therapy. However, as will be appreciated, other human interface devices, such as, but not limited to, a touch screen, may also be employed. Furthermore, in accordance with aspects of the present technique, the user interface 30 may be configured to aid the clinician in navigating through the image management browser to manage and/or organize the images acquired by the medical imaging system 18, and will be described in greater detail with reference to FIGS. 3-9.

Turning now to FIG. 2, a block diagram 40 of one embodiment of the diagnostic system 10 of FIG. 1 is depicted. As previously noted with reference to FIG. 1, the acquisition subsystem 20 (see FIG. 1) is configured to aid in the acquisition of image data from the patient 12 (see FIG. 1). Also, as will be appreciated, an exam is representative of one imaging session of the patient 12. Further, it may be noted that each exam may include one or more series. Additionally, the one or more series may in turn include one or more images. In certain embodiments, the one or more images may include DICOM images 42.

As noted with reference to FIG. 1, image data may be acquired by the acquisition subsystem 20 via the image acquisition device 14 (see FIG. 1). The acquired images may be stored in the data repository 26 (see FIG. 1). In certain embodiments, the data repository 26 may include a local database 44. The image management platform 24 may then access these images from the local database. Alternatively, DICOM images 42 may be obtained by the acquisition subsystem 20 from an archival site, a database, or an optical data storage article. For example, the image management platform 24 may be configured to acquire images stored in the optical data storage article. It may be noted that the optical data storage article may be an optical storage medium, such as a compact disc (CD), a digital versatile disc (DVD), multi-layer structures, such as DVD-5 or DVD-9, multi-sided structures, such as DVD-10 or DVD-18, a high definition digital versatile disc (HD-DVD), a Blu-ray disc, a near field optical storage disc, a holographic storage medium, or another like volumetric optical storage medium, such as, for example, two-photon or multi-photon absorption storage format. Further, these DICOM images 42 so acquired by the acquisition subsystem 20 may be stored locally on the medical imaging system 18 (see FIG. 1). The DICOM images 42 may be stored in the local database 44, for example.

As previously noted with reference to FIG. 1, the processing subsystem 22 is configured to process the images 42, thereby aiding the clinician in identifying disease states, assessing need for treatment, determining suitable treatment options, and/or monitoring the effect of treatment on the disease states. Further, the processing subsystem 22 is shown as including the image management platform 24, where the image management platform 24 is configured to organize and/or manage the acquired images 42, as previously described. In one embodiment, the image management platform 24 may include an image management browser 54, where the image management browser 54 may be configured to aid the clinician in organizing and/or managing the images 42, thereby providing a robust technique of optimizing storage space available on the medical imaging system 18 (see FIG. 1). More particularly, the image management browser 54 may be configured to provide a visual interface to the image management platform 24. In one embodiment, the image management browser 54 may be configured to display a listing of available exams and information associated with the available exams. In other words, the listing of available exams and associated information may be visualized on the display 28 (see FIG. 1), for example. In addition, the clinician may manage and/or organize the images 42 associated with the one or more available exams via the user interface 30 (see FIG. 1). Also, the listing of available exams displayed in the image management browser 54 may include recorded exams 48, deleted exams 52 and/or exams 50 that have been transmitted to remote hosts.

Referring now to FIG. 3, a flow chart of exemplary logic 60 for image management is illustrated. In accordance with exemplary aspects of the present technique, a method for image management is presented. As previously described, it is imperative that the exams stored in the local storage be deleted from time to time in order to optimize usage of the limited storage available on the medical imaging system 18. More particularly, the local storage is typically utilized for temporary storage of the image objects, such as, but not limited to, exams. However, as will be appreciated, the objects may be moved from the temporary storage to a long-term storage for long-term archival, where the long-term storage may include an archival site, a database, a picture archiving and communications system (PACS), or an optical storage article such as a DVD-RAM or MOD. Additionally, the deletion of objects may also entail deleting defective objects without being archived in order to optimize the management of limited local storage. However, this deletion of objects may inadvertently lead to accidental deletion of important image objects. Consequently, restoration of deleted objects, such as DICOM images, to a local database, for example, is crucial to prevent data loss due to an accidental delete. Therefore, in order to circumvent data loss due to an accidental delete, an exemplary method of image management is presented.

In accordance with aspects of the present technique, the method of image management entails storing deleted exams in a temporary storage. Accordingly, a first temporary storage area, such as a Recycle Bin, for instance, may be introduced on the medical imaging system 18 (see FIG. 1), where the Recycle Bin may be configured to aid in temporarily storing the deleted objects thereby allowing the clinician to restore the accidentally deleted objects. It may be noted that the Recycle Bin on the medical imaging system 18 is different from the Recycle Bin associated with the operating system. However, as will be appreciated, storing in the Recycle Bin objects that have been previously archived leads to wasteful usage of a limited Recycle Bin space as the previously archived objects may be restored from corresponding storage media. Consequently, it is desirable to develop a technique that facilitates conservation of the limited storage resources on the medical imaging system 18. Accordingly, the exemplary method of image management described hereinafter is configured to provide the clinician with an option of temporarily deleting the selected objects, such as exams. Additionally, the method of image management may be configured to conserve precious storage space by storing only unarchived objects in a temporary storage, and permanently deleting archived objects.

As previously noted, the image management platform 24 (see FIG. 1) is configured to facilitate management of image objects. Also, the image management browser 54 (see FIG. 2) provides a visual interface to the image management platform 24, where the image management browser 54 is configured to display a listing of available image objects, such as exams. The method starts at step 62 where one or more objects are selected from an available listing of objects in an image management browser, such as the image management browser 54 (see FIG. 2). As used herein, the term “objects” or “image objects” may be used to refer to exams associated with one or more patients, series associated with respective exams, or images associated with corresponding series. In one embodiment, one or more exams may be selected from the listing of exams for temporary deletion. As previously noted, the listing of exams may include archived exams, unarchived exams, or a combination thereof. Further, the listing of exams may be retrieved from corresponding storage media, such as a database, an archival site, or optical storage media, as previously described. Alternatively, in one embodiment, the exam listing may be retrieved from a combination of database, an archival site and an optical storage media. Accordingly, the clinician may select one or more exams from the exam listing in the image management browser 54 for temporary deletion at step 62. In one embodiment, the clinician may use the user interface 30 (see FIG. 1) to select the one or more exams from the image management browser 54 for temporary deletion.

Once the one or more exams have been selected for temporary deletion, the user may click on a “delete” button on the image management browser 54, where the “delete” button may be configured to facilitate the temporary deletion of one or more selected exams. Alternatively, the clinician may also choose to temporarily delete the one or more selected exams by clicking on the “delete” key on the user interface 30, for instance. A trigger signal may be generated in response to the clinician activating the “delete” button, the “delete” key, or both. In one embodiment, the trigger signal may be in an OFF state when the “delete” button and/or the “delete” key are not selected. The status of the trigger signal may be transitioned to an ON state when the “delete” button and/or the “delete” key are selected by the clinician.

Subsequently, at step 64, a check is carried out to verify if the trigger signal has been received by the image management platform 24. In other words, a check is carried out to verify if the status of trigger signal has been transitioned from the OFF state to the ON state. Following step 64, if no change in the status of the trigger signal is detected, the selection of the one or more exams for temporary deletion may be canceled and control may be passed back to the image management browser 54. However, if the image management platform 24 detects a change in status of the trigger signal from the OFF state to the ON state, the image management platform 24 may be configured to notify the clinician about the change in status of the trigger signal, as depicted by step 66. In a presently contemplated configuration, the clinician may be notified about the change in status of the trigger signal via a message box. For example, the image management platform 24 may be configured to display a message box on the image management browser 54, where the message box may be configured to provide the clinician with an option of confirming the deletion of the one or more selected exams.

As previously noted, in order to circumvent accidental deletion of relevant exams, the one or more exams selected for deletion may be moved to a temporary storage. Furthermore, optimization of usage of the limited storage resources available on the medical imaging system 18 may entail deletion of exams, where the exams selected for deletion may include archived exams, unarchived exams, or both, as previously described. However, storage of archived exams in the temporary storage results in wasteful usage of the temporary storage space as the archived exams may be retrieved from corresponding storage media. Consequently, in accordance with exemplary aspects of the present technique, archived exams from the one or more selected exams may be permanently deleted, while only the unarchived exams from the one or more selected exams may be moved to the temporary storage, thereby resulting in conservation of limited resources of the temporary storage.

Accordingly, a check may be carried out at step 68 to verify if the clinician confirmed the temporary deletion of the one or more selected exams. If the clinician confirmed the deletion of the one or more selected exams, a further check may be carried out at step 70 to determine archival status of each of the one or more selected exams. It may be noted that the archival status may include an archived state or an unarchived state. Also, as will be appreciated, the archival status of the one or more selected exams may be obtained from the corresponding storage media, such as a local database, for example. Further, it may be noted that an exam is said to be archived only if all the series corresponding to a given exam are archived.

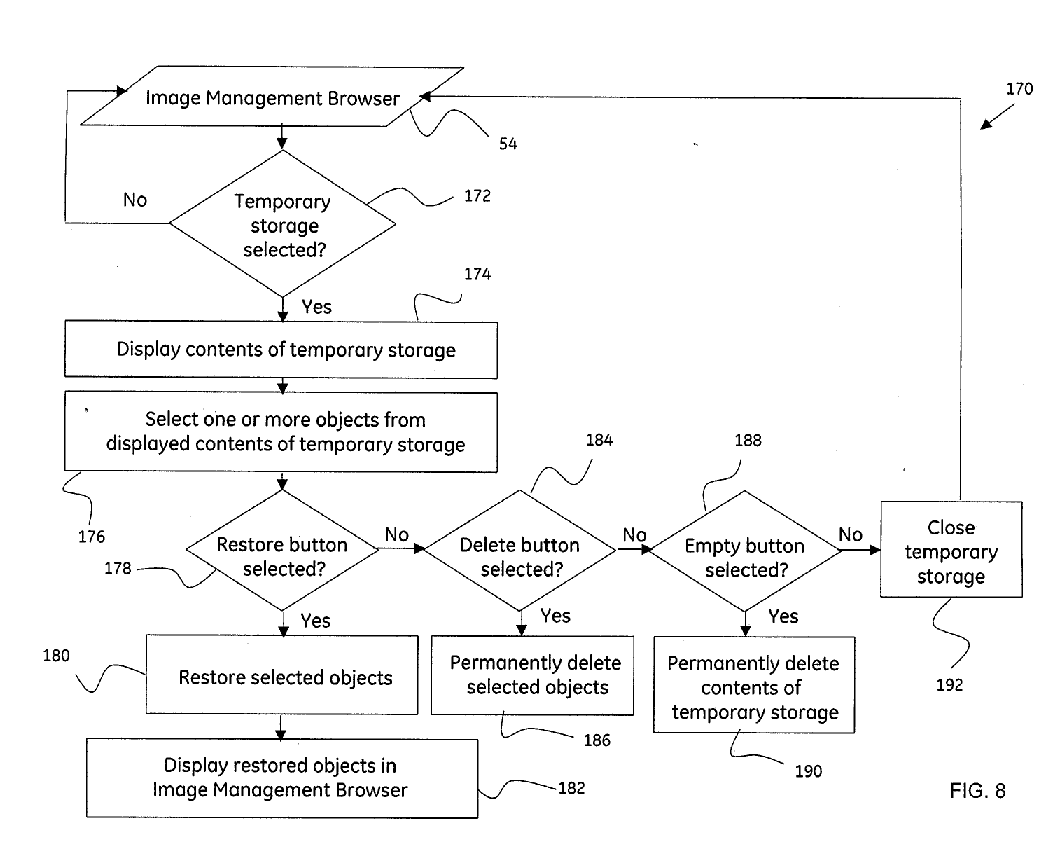

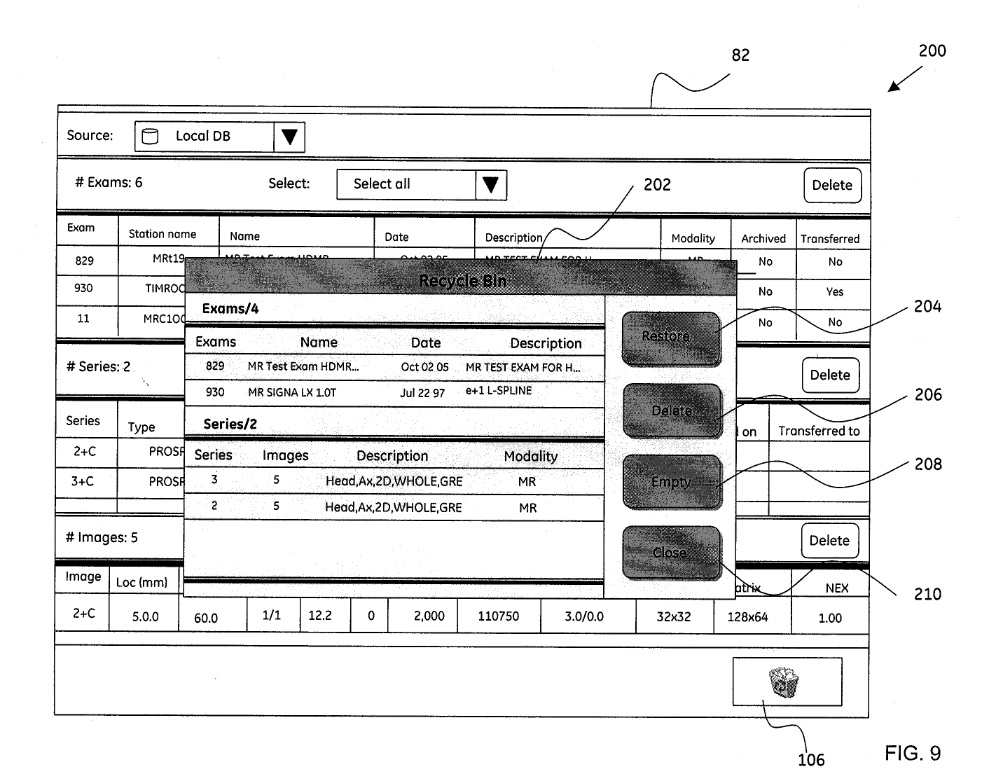

Once the archival status of each of the one or more selected exams is determined, the selected exams may be categorized based upon the respective archival status. For example, in one embodiment, the selected exams may be categorized into two groups based upon the archival status, where the two groups may include an archived exams group and an unarchived exams group. Following the categorization of each of the one or more selected exams, all exams in the archived exams group may be permanently deleted as indicated by step 72, while all exams in the unarchived exams group may be moved to temporary storage as depicted by step 74. As previously noted, the temporary storage is configured to facilitate restoration of the deleted unarchived exams. Accordingly, the clinician may retrieve the unarchived exams from the temporary storage. The process of retrieving the unarchived exams from the temporary storage will be described in greater detail with reference to FIGS. 8-9.

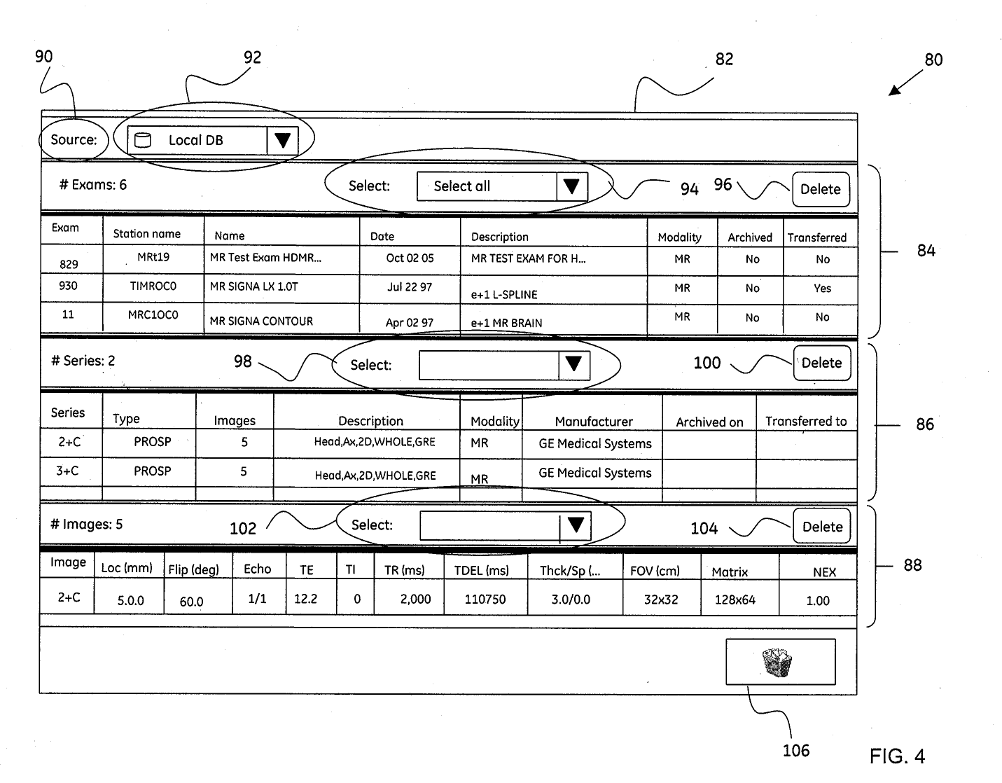

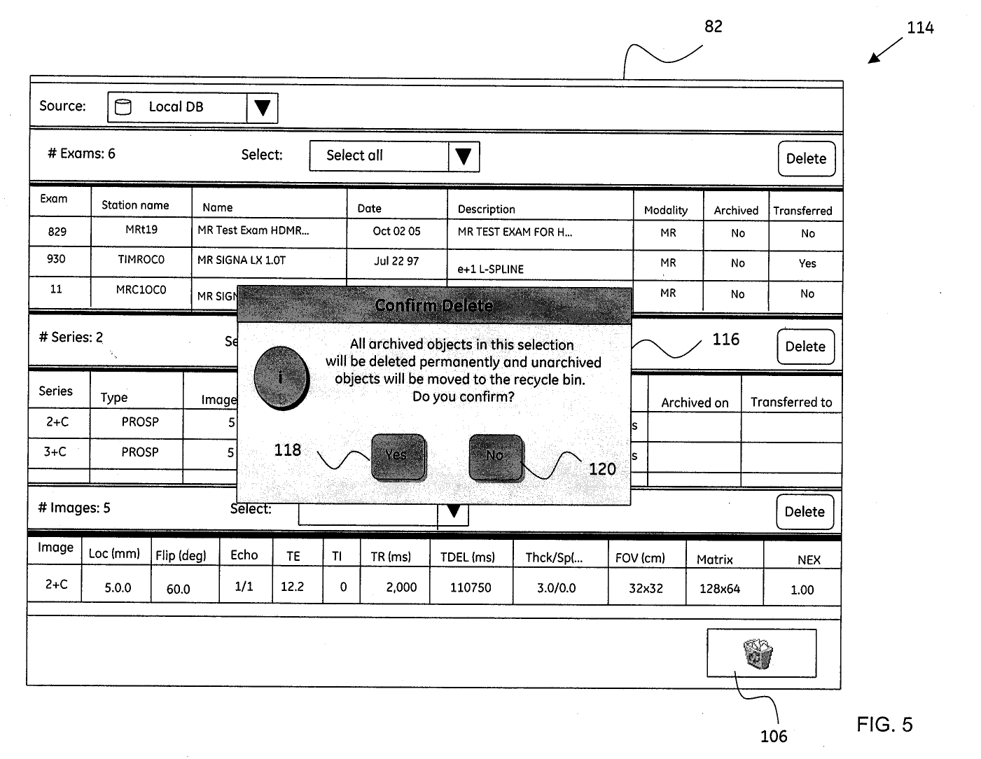

Steps 62-74 may be better understood with reference to FIGS. 4-5. Turning now to FIG. 4, a diagrammatic illustration 80 of an exemplary process of image management is depicted. Reference numeral 82 represents a front view of an image management browser, such as the image management browser 54 (see FIG. 2). In the illustrated embodiment, the image management browser 82 is shown as including three regions 84, 86 and 88. As previously noted, there may be one or more exams associated with each patient, where each exam may include a corresponding series, and where each series may include one or more associated images. Accordingly, in a presently contemplated configuration, the image management browser 82 may be partitioned into three regions, where the three regions include an exam portion, a series portion, and an image portion. Reference numeral 84 is representative of the exam portion of the image management browser 82, where a listing of exams stored in a corresponding storage media is displayed. As previously noted, the corresponding storage media may include a database, an archive site or an optical storage media. In accordance with aspects of the present technique, the image management browser 82 may be configured to allow the clinician to select a source 90 of the exam listing. In other words, the clinician may be allowed to select the storage media to facilitate retrieval of the exam listing. Accordingly, in one embodiment, the clinician may select the source of the exam listing using a combo-box 92.

Similarly, the series portion of the image management browser 82 may be used to display a series corresponding to an exam displayed in the exam portion 84 and is generally represented by reference numeral 86. In addition, the image portion of the image management browser 82 may be represented by reference numeral 88 and is configured to display a set of images associated with a member of a series listed in the series portion 86 of the image management browser 82.

Referring now to the exam portion 84 of the image management browser 82, a listing of available exams retrieved from the source 90 is displayed. The clinician may then select one or more exams for temporary deletion from this exam listing in the exam portion 84 of the image management browser 82. Following the selection of the one or more exams for deletion, the user may select a “delete” button 96 that is configured to facilitate the temporary deletion of the one or more selected exams. Alternatively, the clinician may select a “delete” key on the user interface 30 (see FIG. 1) to temporarily delete the one or more selected exams. More particularly, once the “delete” button 96 and/or the “delete” key has been selected, the image management platform 24 (see FIG. 1) is configured to display a message to the clinician indicative of the selection of one or more exams for temporary deletion.

In a presently contemplated configuration, the clinician may be notified about the selection of the one or more exams for deletion via a message box. Turning now to FIG. 5, a front view 114 of the image management browser 82 including a message box 116 is illustrated. In one embodiment, the message box 116 may be configured to provide the clinician with an option of confirming the deletion of the one or more selected exams. More particularly, in accordance with aspects of the present technique, the message box 116 may be configured to notify the clinician that all archived exams will be permanently deleted, while the unarchived exams will be moved to a temporary storage.

With continuing reference to FIG. 5, reference numeral 118 is representative of a “Yes” button, where the “Yes” button 118 may be configured to confirm the deletion of the one or more selected exams. In a similar fashion a “No” button 120 may be configured to be indicative of a cancellation of the deletion of the one or more selected exams. If the clinician confirms the deletion of the one or more selected exams by selecting the “Yes” button 118, the image management platform 24 (see FIG. 2) is configured to determine the archival status of each of the one or more selected exams, as previously described with reference to FIG. 3. Further, based upon the archival status, each of the one or more selected exams is categorized as either an archived exam or an unarchived exam. Subsequently, all the archived exams are permanently deleted, while the unarchived exams are moved to a temporary storage, such as a Recycle Bin. The unarchived exams that have been moved to the temporary storage may then be restored, as will be described in greater detail with reference to FIGS. 8-9. However, if the clinician selects the “No” button 120, the deletion of the one or more exams is canceled and control is returned to the image management browser 82.

With returning reference to FIG. 4, the clinician may select one or more exams for deletion from the list of available exams, as previously described. Further, the exam listing may include archived exams, unarchived exams or both. In accordance with aspects of the present technique, one or more selection shortcuts are provided in the exam portion 84, the series portion 86 and the image portion 88, where selection shortcuts may be configured to further speed up the temporary deletion of the selected exams. In one embodiment, available shortcuts may be tailored to correspond to a region of image management browser 54. By way of example, if the source 90 in the exam portion 84 of the image management browser 82 includes a local database, then a possible listing of available selection shortcuts in the exam portion 84 of the image management browser 54 may include “none”, “all”, “all archived”, and “all unarchived”. In a presently contemplated configuration, the clinician may access the selection shortcuts via a selection combo-box 94 in the exam portion 84 of the image management browser 82. These selection shortcuts enable the clinician to tailor selection of exams for temporary deletion, thereby speeding up the deletion process.

Referring now to the series portion 86 of the image management browser 82, a listing of series corresponding to a given exam in the exam portion 84 is displayed. Here again, the clinician may select one or more series for temporary deletion as described with reference to the selection of one or more exams for deletion. Subsequently, the user may select a “delete” button 100 corresponding to the series portion 86 of the image management browser 82 to delete the selected series. The image management platform 24 may then determine archival status of each of the selected one or more series and categorize the selected series based upon the corresponding archival status. Further, as described hereinabove, the archived series may be permanently deleted, while the unarchived series may be moved to a temporary storage, such as the Recycle Bin. Also, the clinician may choose a selection shortcut corresponding to the series portion 86 from a selection combo-box 98 to speed up the deletion process. The selection shortcuts corresponding to the series portion 86 may also include “none”, “all”, “all archived”, and “all unarchived”.

Further, a listing of images corresponding to a given series may be displayed in the image portion 88 of the image management browser 82. In addition, as described with reference to the exam and series portions 84, 86 of the image management browser 82, the clinician may select one or more images to be temporarily deleted. Once the clinician selects one or more images for deletion, the clinician may select a “delete” button 104 corresponding to the image portion 88 of the image management browser 82. The image management platform 24 may then determine the archival status of each of the one or more selected images and accordingly categorize the selected images. For example, the selected images may be categorized as one of an archived image or an unarchived image. Subsequently, the archived images may be permanently deleted, while the unarchived images may be moved to a temporary storage, such as the Recycle Bin. The deleted unarchived images may then be restored from the Recycle Bin. Here again, the clinician may speed up the process of deleting images by using one or more selection shortcuts that may be accessed via a selection combo-box 102. By way of example, the available selection shortcuts corresponding to the image portion 88 may include “none” and “all”. It may be noted that the “archived” and “all archived” options are not available as selection shortcuts in the image portion 88 as archival is allowed only at exam and series levels.

Moreover, it may be noted that at each of the exam portion 84, the series portion 86, and the image portion 88 of the image management browser 82, the clinician may select one or more objects for deletion and select the “Shift” and “Delete” keys on the user interface 30 to permanently delete all the selected objects. By way of example, the clinician may select the “all archived” selection shortcut via the selection combo-box 94 to select all the archived exams in the exam listing and press the “Shift” and “Delete” keys on the user interface 30 to permanently delete all the archived exams.

In accordance with further aspects of the present technique, the image management browser 82 may also include a “Recycle Bin” button 106, where the “Recycle Bin” button 106 may be configured to aid the clinician in the restoration of contents of the temporary storage and will be described in greater detail with reference to FIGS. 8-9. Also, as will be described hereinafter, the contents of the temporary storage, such as the deleted unarchived objects, may be restored and reinstalled into storage media, such as a local database, for example.

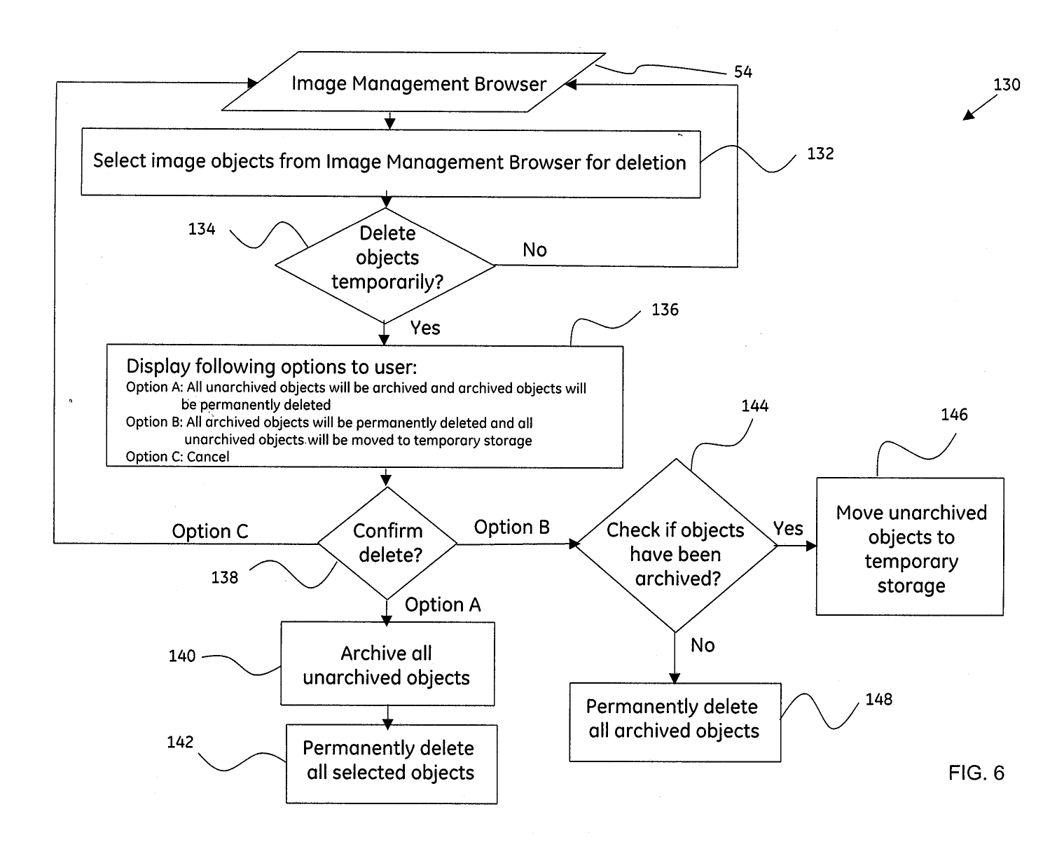

FIG. 6 is a flow chart of exemplary logic 130 for image management. In accordance with exemplary aspects of the present technique, another method for image management is presented. As previously described, the limited storage available on the medical imaging system 18 (see FIG. 1) may be conserved by deleting objects that are stored in the local storage. An alternate exemplary method of image management is presented in accordance with aspects of the present technique. It may be noted that as used herein, the term “object” is used to refer to an exam, a series or an image depending on a region in the image management browser 54 (see FIG. 2).

The method starts at step 132 where one or more objects are selected for temporary deletion from an available listing of objects in an image management browser, such as the image management browser 54 (see FIG. 2). The listing of objects may include archived objects, unarchived objects, or a combination thereof and may be retrieved from corresponding storage media, as previously described. Once the one or more objects have been selected for temporary deletion, the user may click on a “delete” button on the image management browser 54, where the “delete” button may be configured to facilitate the temporary deletion of one or more selected objects. Subsequently, at step 134, a check may be carried out to verify if “delete” button was selected by the clinician. Following the check at step 134, if the image management platform 24 (see FIG. 1) detects the selection of the “delete” button, the image management platform 24 may be configured to notify the clinician about the selection of one or more objects for deletion via a message box. In one embodiment, the image management platform 24 may be configured to display a message box on the image management browser 54, where the message box may be configured to provide the clinician with options of confirming or canceling the deletion of the one or more selected objects.

As previously noted, in order to circumvent accidental deletion of relevant objects, the one or more objects selected for deletion may be moved to a temporary storage. Consequently, in accordance with exemplary aspects of the present technique, the image management platform 24 may be configured to automatically archive all the unarchived objects and permanently delete all the selected objects, thereby resulting in a single step operation of archiving and deleting the selected objects.

Accordingly, as indicated by step 136, the image management platform 24 may be configured to display a message box on the image management browser 54, where the message box may be configured to provide the clinician with a plurality of options associated with the deletion of the one or more selected objects. In a presently contemplated configuration, the message box may be configured to allow the clinician to select one of three options. A first option may be configured to archive all the unarchived objects and permanently delete all the selected objects. Further, a second option may be configured to permanently delete all the archived objects, while the unarchived objects may be moved to a temporary storage. In addition, a third option may allow the clinician to cancel the selection of objects for deletion.

Subsequently, a check may be carried out at step 138 to identify the option selected by the clinician. If the clinician confirmed the deletion of the one or more selected objects by selecting “Option A”, all the unarchived objects may be archived as indicated by step 140. Further, all the objects selected at step 132 may be deleted at step 142. However, if the clinician chooses “Option B”, steps 144-148 may be performed. It may be noted that steps 144-148 are similar to steps 70-74 of FIG. 3. More particularly, if the clinician selects “Option B”, archival status of each of the selected one or more objects may be determined at step 144 and each of the selected one or more objects may be categorized based upon the respective archival status. In one embodiment, the selected objects may be categorized as either an archived object or an unarchived object. Following the categorization of each of the one or more selected objects, all objects in the unarchived objects group may be moved to temporary storage as depicted by step 146, while all objects in the archived objects group may be permanently deleted as indicated by step 148. Also, the temporary storage is configured to facilitate restoration of the unarchived objects, as previously noted. Also, if the clinician selects “Option C”, the selection of objects for deletion is canceled and control is returned to the image management browser 54.

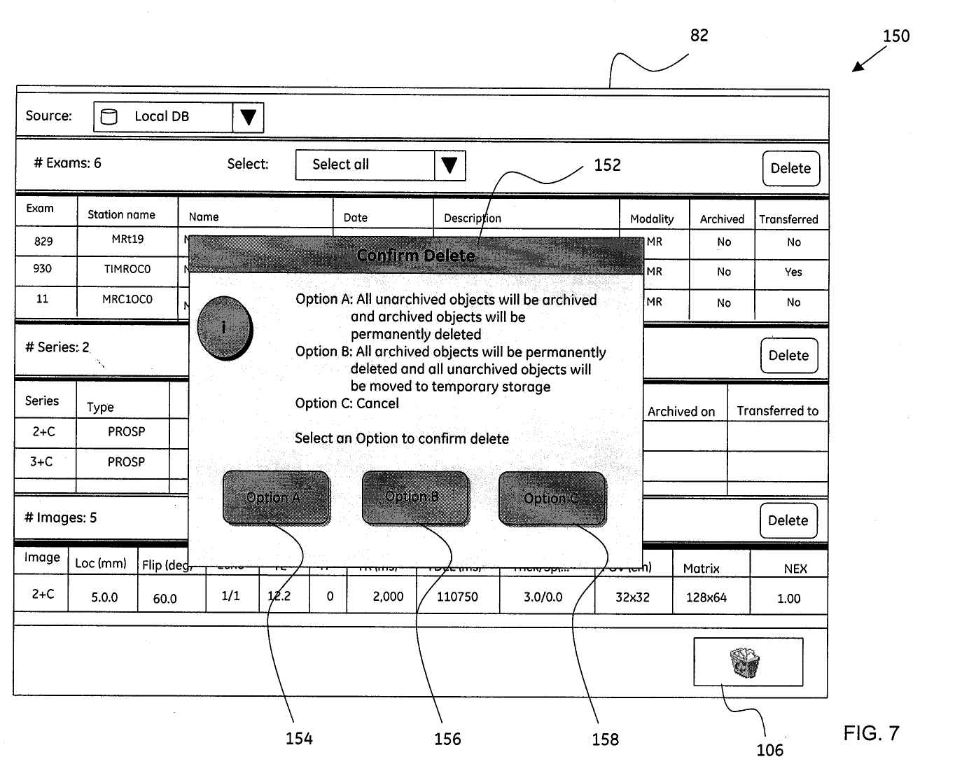

Steps 132-148 may be better understood with reference to FIG. 7. As described hereinabove, the clinician may be presented with one or more options of deleting the selected objects. In a presently contemplated configuration, the clinician may be notified about the options for deleting the one or more selected objects via a message box. Turning now to FIG. 7, a front view 150 of the image management browser 82 including a message box 152 is illustrated. In one embodiment, the message box 152 may be configured to provide the clinician with three options of confirming the deletion of the one or more selected objects. More particularly, in accordance with aspects of the present technique, the message box 152 may be configured to notify the clinician that by selecting “Option A”, all unarchived objects will be archived and all the selected objects will be permanently deleted. Additionally, the message box 152 may be configured to notify the clinician that by selecting “Option B” all archived objects will be permanently deleted, while the unarchived objects will be moved to a temporary storage. Further, by selecting “Option C”, the selection of the one or more objects for deletion will be canceled and control is returned to the image management browser 82.

Reference numeral 154 is representative of an “Option A” button, where the “Option A” button may be configured to archive all unarchived objects in the selection and subsequently delete all the selected objects. Similarly, an “Option B” button 156 may be configured to permanently delete all archived objects and move the unarchived objects to a temporary storage such as a Recycle Bin. Furthermore, an “Option C” button 158 may be indicative of a cancellation of the deletion of the one or more selected objects, and control is returned to the image management browser 54.

As described hereinabove, unarchived objects may be moved to a temporary storage, such as a Recycle Bin, in order to circumvent loss of data due to an accidental deletion of critical objects. Also, as previously noted, the unarchived objects may be restored from the temporary storage to facilitate storing in a storage medium, such as a database, for instance. Accordingly, FIG. 8 is a flow chart of exemplary logic 170 for restoring objects from the temporary storage. The method starts at step 172 where a check is carried out to verify if a “Recycle Bin” button on the image management browser 54 (see FIG. 2) is selected. The “Recycle Bin” button may include the “Recycle Bin” button 106. If the “Recycle Bin” button 106 has been selected, then the image management platform 24 (see FIG. 1) may be configured to display the contents of the temporary storage, as depicted by step 174. It may be noted that the contents of the temporary storage includes the deleted unarchived objects. Subsequently, at step 176, the clinician may select one or more objects from the contents of the temporary storage. Following step 176, the clinician may choose to restore the selected objects from the temporary storage. Alternatively, the selected objects may be deleted from the temporary storage. Furthermore, the clinician may also choose to delete all the objects from the temporary storage.

Accordingly, a check is carried out at step 178 to verify if the clinician elected to restore the selected objects. If it is verified that the selected objects need to be restored, then the selected objects may be restored as indicated by step 180. The deleted objects may be restored to a corresponding source of exam listing. For example, if the source of exam listing (see FIG. 4) is the local database, then the selected objects may be restored to a local database. Subsequently, at step 182, the restored objects may be displayed in the image management browser 54. However, if the clinician chooses not to restore the selected objects at decision block 178, a further check may be carried out, at step 184, to verify if the clinician elected to delete the selected objects. The image management platform 24 may be configured to permanently delete the selected objects, as depicted by step 186, if the clinician chooses the option of deleting the objects. Alternatively, another check may be carried out at step 188 to verify if the clinician opted to delete all the contents of the temporary storage. If the clinician selected the option of deleting all the contents of the temporary storage, then the image management platform 24 may be configured to permanently delete all the objects in the temporary storage, as indicated by step 190. On the other hand, the clinician may elect to close the display showing the contents of the temporary storage. Accordingly, the image management platform 24 may be configured to close the display of contents of the temporary storage at step 192 and return control to the image management browser 54.

Here again, steps 172-192 may be better understood with reference to FIG. 9. Turning now to FIG. 9, a front view 200 of the image management browser 82 including a dialog box 202 is illustrated. As described hereinabove, the image management browser 82 may be configured to aid the clinician in visualizing and/or managing the contents of the temporary storage. More particularly, the image management browser 82 may be configured to allow the clinician to view the contents of the temporary storage and present the clinician with one or more options of managing the contents of the temporary storage. In a presently contemplated configuration, the clinician may be allowed to visualize the contents of the temporary storage by selecting the “Recycle Bin” button 106.

In one embodiment, in addition to displaying the contents of the temporary storage, the dialog box 202 may be configured to provide the clinician with four options of managing the contents of the temporary storage. The clinician may select one or more objects from the contents of the temporary storage. Subsequently, the clinician may elect to restore the selected objects from the temporary storage by selecting a “Restore” button 204. Following the selection of the “Restore” button 204, the selected objects may be restored from the temporary storage. In one embodiment, the deleted objects may be restored to a corresponding source of exam listing, as previously described. Also, the restored objects may be displayed in the appropriate section of the image management browser 82. The clinician may also choose to delete the selected objects from the temporary storage by selecting a “Delete” button 206, where the “Delete” button 206 is configured to permanently delete the selected objects from the temporary storage. In a similar fashion, the clinician may opt to delete all the objects in the temporary storage by selecting an “Empty” button 208. Further, by selecting a “Close” button 210, the clinician may close the dialog box 202 and return control to the image management browser 54.

As will be appreciated by those of ordinary skill in the art, the foregoing example, demonstrations, and process steps may be implemented by suitable code on a processor-based system, such as a general-purpose or special-purpose computer. It should also be noted that different implementations of the present technique may perform some or all of the steps described herein in different orders or substantially concurrently, that is, in parallel. Furthermore, the functions may be implemented in a variety of programming languages, such as C++ or Java. Such code, as will be appreciated by those of ordinary skill in the art, may be stored or adapted for storage on one or more tangible, machine readable media, such as on memory chips, local or remote hard disks, optical disks (that is, CDs or DVDs), or other media, which may be accessed by a processor-based system to execute the stored code. Note that the tangible media may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

The method of image management and the system for image management described hereinabove dramatically simplify procedural workflow of image management and enhance speed of procedural time taken to organize image objects. Further, temporary storage in the form of a Recycle Bin serves as a powerful tool configured to aid clinicians in the restoration of accidentally deleted image objects. Moreover, the added intelligence to differentiate between archived and unarchived objects during the temporary deletion of selected objects results in acceleration of the process of cleaning up storage space, and thereby ensures optimal usage of the Recycle Bin space which is configured to include only unarchived objects. Additionally, during the temporary deletion of objects, the unarchived objects may be automatically archived and all the selected objects may be permanently deleted, thereby simplifying the workflow of the deletion process by providing a single step operation to archive and delete objects. Also, the selection shortcuts serve to simplify the workflow and add to customer productivity gain.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for image management, the method comprising:
selecting one or more objects from an object listing for deletion, wherein the one or more objects comprise an archived object, an unarchived object, or both;
determining archival status of the one or more selected objects, wherein the archival status comprises one of an archived state or an unarchived state; and
moving unarchived objects to a first storage, wherein the first storage is configured to facilitate restoration of the unarchived objects.

2. The method of claim 1, wherein the object comprises an exam, a series, or an image.

3. The method of claim 1, wherein determining archival status comprises:
examining the archival status of the one or more selected objects;
categorizing the one or more selected objects based upon the archival status; and
permanently deleting the archived objects.

4. The method of claim 1, further comprising receiving the object listing from a second storage.

5. The method of claim 4, wherein the second storage comprises one of a local database, an archive, optical storage media, or a combination thereof.

6. The method of claim 1, wherein selecting one or more objects comprises one or more options of filtering the one or more objects from the object listing for deletion.

7. The method of claim 1, further comprising restoring unarchived objects from the first storage.

8. The method of claim 7, wherein restoring unarchived objects comprises:
displaying contents of the first storage;
selecting one or more unarchived objects from the displayed contents; and
storing the selected objects in a second storage.

9. The method of claim 8, further comprising displaying the restored objects in the object listing.

10. The method of claim 1, wherein the one or more objects is representative of image data acquired via an imaging system, wherein the imaging system comprises one of a computed tomography imaging system, a positron emission tomography imaging system, a magnetic resonance imaging system, an X-ray imaging system, a nuclear medicine imaging system, an ultrasound imaging system, or combinations thereof.

11. A computer readable medium comprising one or more tangible media, wherein the one or more tangible media comprise:
code adapted to select one or more objects from an object listing for deletion, wherein the one or more objects comprise an archived object, an unarchived object, or both;
code adapted to determine archival status of the one or more objects, wherein the archival status comprises one of an archived state or an unarchived state; and
code adapted to move the unarchived objects to a first storage, wherein the first storage is configured to facilitate restoration of the unarchived objects.

12. The computer readable medium, as recited in claim 11, wherein code adapted to determine archival status comprises:
code adapted to examine the archival status of the one or more selected objects;
code adapted to categorize the one or more objects based upon the archival status; and
code adapted to permanently delete the archived objects.

13. The computer readable medium, as recited in claim 11, further comprising code adapted to receive the one or more objects from a second storage.

14. The computer readable medium, as recited in claim 11, wherein code adapted to select one or more objects comprises code adapted to provide one or more options of filtering the one or more objects from the object listing for deletion.

15. The computer readable medium, as recited in claim 11, further comprising code adapted to restore unarchived objects from the first storage.

16. The computer readable medium, as recited in claim 15, wherein code adapted to restore unarchived objects comprises:
code adapted to display contents of the first storage;
code adapted to select one or more unarchived objects from the displayed contents; and
code adapted to store the selected objects in a second storage.

17. The computer readable medium, as recited in claim 16, further comprising code adapted to display the restored objects in the object listing.

18. A system for image management, comprising:
an acquisition subsystem configured to acquire one or more objects representative of one or more patients;
a processing subsystem in operative association with the acquisition subsystem and comprising an image management platform configured to:
select one or more objects from an object listing for deletion, wherein the one or more objects comprise an archived object, an unarchived object, or both;
determine archival status of the one or more objects, wherein the archival status comprises one of an archived state or an unarchived state; and
move the unarchived objects to a first storage, wherein the first storage is configured to facilitate restoration of the unarchived objects.

19. The system of claim 18, wherein the system is further configured to receive the one or more objects from a second storage.

20. The system of claim 18, wherein the image management platform is further configured to:
examine the archival status of the one or more selected objects;
categorize the one or more objects based upon the archival status; and
permanently delete the archived objects.

21. The system of claim 18, wherein the image management platform is further configured to provide one or more options of filtering the one or more objects from the object listing for deletion.

22. The system of claim 18, wherein the image management platform is further configured to restore unarchived objects from the first storage.

23. The system of claim 22, wherein the image management platform is further configured to:
display contents of the first storage;
select one or more unarchived objects from the displayed contents; and
store the selected objects in a second storage.

24. The system of claim 23, wherein the image management platform is further configured to display the restored objects in the object listing.

25. The system of claim 18, further comprising a display configured to display the object listing.
